(19) United States
(12) Patent Application Publication
(10) Pub. No.: US 2018/0221755 A1
(43) Pub. Date: Aug. 9, 2018

(54) GAME SYSTEM FOR PLAYING GAMES BASED ON INFORMATION ON INDIVIDUAL STATES

(71) Applicant: Shuho Takahashi, Torrance, CA (US)

(72) Inventor: Shuho Takahashi, Torrance, CA (US)

(21) Appl. No.: 15/947,832

(22) Filed: Apr. 8, 2018

Related U.S. Application Data
(63) Continuation of application No. 14/743,970, filed on Jun. 18, 2015.

(51) Int. Cl. A63F 1/00; G09B 7/06; A63F 9/18

(52) U.S. Cl. CPC A63F 1/00; G09B 7/066; A63F 9/183; A63F 9/18

(57) ABSTRACT

A game system for playing games is provided based on information pertaining to 51 individual states in the USA including Washington D.C. The game system includes: a set of 51 cards having a front side illustrating 51 state flags, respectively, wherein a back side of each of the 51 cards is configured to show at least the name of the state associated with the state flag illustrated on the front side and the number of electoral votes assigned to the state; and a question and answer unit configured to provide one or more sets of questions and answers, each set including 51 questions and 51 corresponding answers related to state information pertaining to the 51 states, respectively.

### CROSS-REFERENCE TO RELATED APPLICATION

This application is a continuation of the U.S. patent application Ser. No. 14/743,970 filed on Jun. 18, 2015.

### BACKGROUND

“Karuta” is a Japanese card game based typically on two sets of cards. All the cards in the first set are initially laid in an array on a table or a floor to be picked up by players; while a question, hint, quiz or trivia is written on each of the second set of cards, which are held by a host. The answers to the questions are expressed, in words, pictures, or any suitable form, on the first set of cards, respectively. Thus, the number of cards in the first set and the number of cards in the second set are typically the same. The players compete to pick up a card as fast as possible, among the first set of cards that are laid within arm's reach, which each player thinks illustrates a right answer to a question while the question on a card in the second set is being read out by the host. The questions are read out sequentially, and the player who picked up the largest number of cards is determined to be the winner.

“Iroha Garuta” is an example of “Karuta,” which is popular, educational, and easy to understand. Forty eight proverbs are written on the cards in the second set, respectively, each starting with a different syllable. The first set of cards are initially laid in an array within arm's reach of the players, and express the proverbs, respectively, as depicted in the picture, each including the corresponding starting syllable of the proverb. The players compete to pick up cards in the first set sequentially, corresponding to the proverbs sequentially read out by the host. The winner is the player who picked up the largest number of cards, thereby indicating that he/she is the best and fastest in recognizing the proverbs and the written characters (representing the syllables).

Generally, card games are designed to be educational and fun to play. A wide variety of cards games have been devised in many cultures in the course of long history.

### BRIEF DESCRIPTION OF THE DRAWINGS

FIG. 1 illustrates an example of a front view of a set of cards according to an embodiment.

FIG. 2 illustrates an example of a list of questions and corresponding answers according to an embodiment.

FIG. 3 illustrates an example of a rear view of one of the 51 cards in the set according to an embodiment.

FIG. 4 illustrates an example of display on the screen of a computer.

FIG. 5 illustrates an example of the table in which the information is arranged.

FIG. 6 is a flowchart illustrating an example of the process of carrying out the present card game.

FIG. 7 is a flowchart illustrating another example of the process of carrying out the present card game.

FIG. 8 illustrates another example illustrating the back side of the card having the image of the California state flag on the front side.

### DETAILED DESCRIPTION

A card game is provided according to the present invention to help people learn history, politics, industry, geography and other information pertaining to individual states in the USA. The present card game is designed to be both entertaining and enlightening, and expected to enhance interest and participation of voters in the upcoming presidential election. The card game according to the present invention can be configured to be physical by using physically fabricated cards such as those made of paper, plastic or other material that provides suitable stiffness and flexibility for handling. Alternatively, the present card game can be configured to be electrical by using a computer program with a proper user interface enabling each player to participate in the card game using his/her computer. Here, the computers include but not limited to a desktop computer, a game machine, a smartphone, a laptop computer, and a tablet. Two or more players can be coupled to respective computers, whereby each player can use a mouse, a stylus, a finger, or other conventional means coupled with the user interface to input information or selection necessary for the OS or a processor to recognize for carrying out the game. For example, the cards may be configured by the computer program and displayed on a screen of each computer, wherein multiple players are coupled to respective computers, and each player can use a mouse, a stylus, a finger, or other means to select by clicking on or touching any of the displayed cards on the screen as his/her pick. Details of the card game according to the present invention are described below with reference to accompanying drawings.

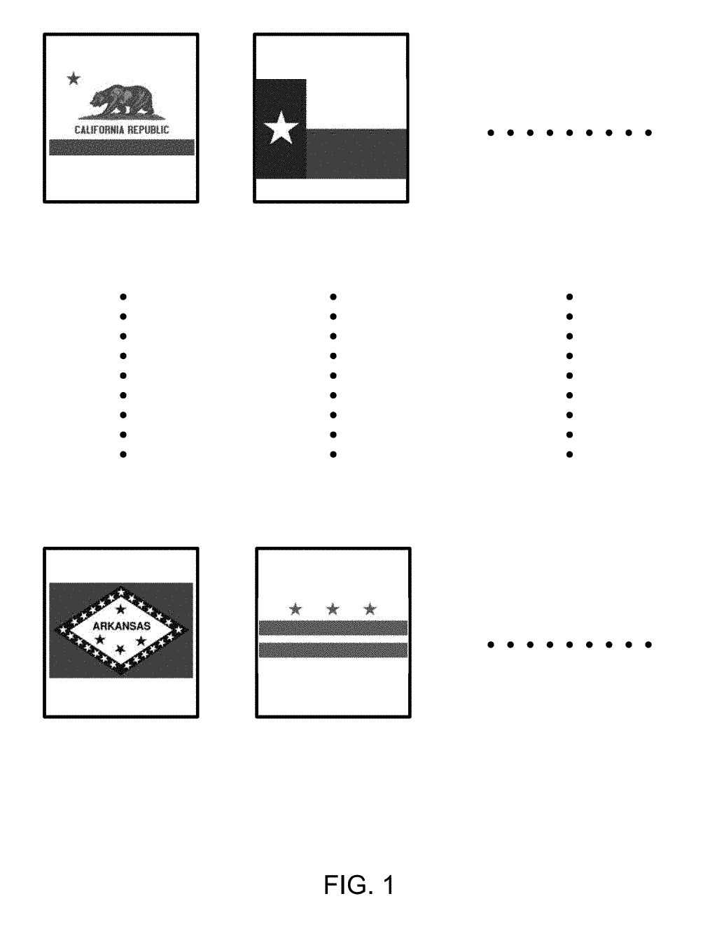

An embodiment of configuring the game by using physically fabricated cards is described first. FIG. 1 illustrates an example of a front view of a set of cards according to an embodiment. The cards are laid or displayed substantially in an array to be accessible by two or more players. The accessibility is configured to be physical in this case; that is, these cards made of paper, plastic or any material that provides proper stiffness and flexibility for handling are laid or displayed on a table, a floor or other suitable surface within arm's reach of each of the players. A total of 51 cards in the set are provided, corresponding to 51 states including Washington D.C., illustrating the 51 state flags, respectively, on the front side. Initially, all the cards in the set are displayed with the front side up, showing the front side illustrating the 51 state flags, respectively. These cards are shuffled well prior to starting the game so that they are laid or displayed in a random arrangement each time. In the example illustrated in FIG. 1, the flags of California and Texas are located at the left upper portion of the array; and the flags of Arkansas and Washington D.C. are located at the left lower portion of the array.

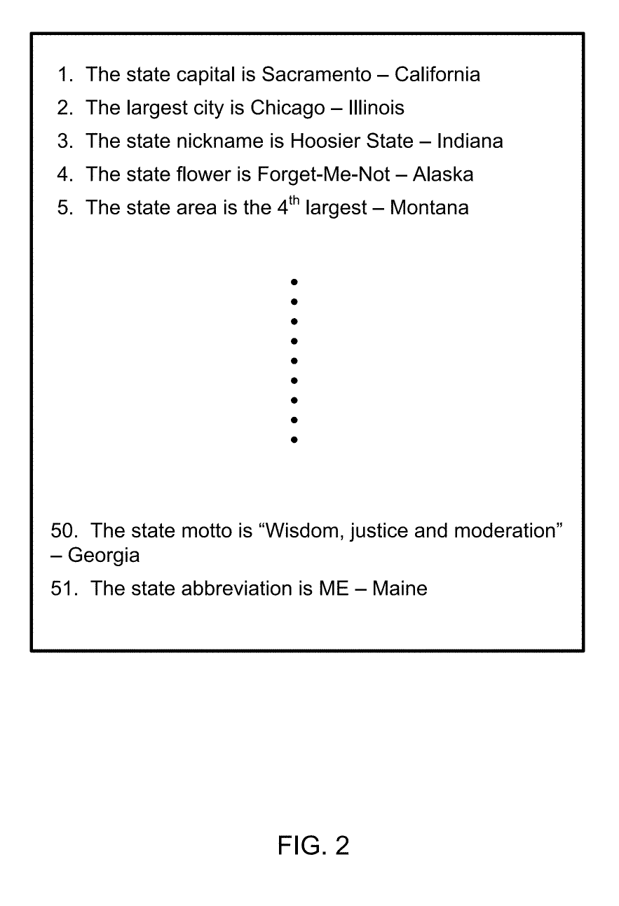

FIG. 2 illustrates an example of a list of questions and corresponding answers according to an embodiment, wherein the questions and corresponding answers are listed with one-to-one correspondence. The questions and answers are based on information pertaining to the 51 individual states. In the physical card game, the questions can be posed by reading out one-by-one by a host, randomly or sequentially, requiring the players to compete in speed to pick up a right card that shows a correct answer to each question, wherein the right card has the illustration of the state flag of the state that is the correct answer to the question. The host may be a human or a machine capable of emitting audible words of the questions one by one. In this picking up process, the players are allowed to compete in speed to select a card, for example, by physically reaching a card that each player thinks is a right card among the laid/displayed cards on a table, a floor, or other surface, as soon as the question is read out by the host; thereafter, only the player who selected or reached any of the displayed cards first is allowed to take the card. However, the card that the player took may be a wrong card, i.e., a wrong answer to the question. Then, he/she is not allowed to keep the card. Otherwise, he/she is allowed to keep the card. Therefore, to win the game, a player must try to pick up a right card for each question as fast as he/she can. A rule may be set in such a way that he/she must return the wrong card to the place where the cards are displayed; put the wrong card in a bin; or do some other predetermined action, so as to disallow the player who answered wrong from keeping the card. Optionally, an additional rule may be set so that the player who took a wrong card must be restrained from participation until another player takes a wrong card for one of the subsequent questions. In any case, the wrong card should be placed back in a location where it is available and accessible to all the players as a right card to be selected for another question. A rule may be set in such a way that if the card taken by the first player is wrong, the first player returns the card to the display area, and the player who selected or reached any of the other displayed cards second in speed is allowed to take the card he/she selected or reached; and if the card is right, the second player is allowed to keep the card. An alternative rule may be set in such a way that if the card taken by the first player is wrong, the first player returns the card to the display area, and the game simply proceeds to the next question. Under any rules, only the player who took a right card is allowed to keep the card. Thus, while the game proceeds and the questions are posed one by one, the number of displayed cards to select or reach will decrease as right cards are kept by the players. During any time in the game, for example, while a question is read out, or in between competing in speed, the players may be allowed to rearrange the remaining displayed cards to change the locations of the cards. Since the location of each card is not fixed in this case, it is difficult for the players to memorize the locations, thereby providing the players with additional enjoyment in dealing with a moving target as in hunting.

There are 51 questions having 51 answers which are the 51 state names, respectively. That is, a one-to-one relationship is configured between the 51 questions and the 51 answers that are the 51 state names. The physical media reciting these questions and corresponding answers can be one sheet, a second set of 51 separate cards or any other suitable form. The first question corresponding to the first line in the example illustrated in FIG. 2 is “the state capital is Sacramento in what state?” The answer is California, which is written on the same line so that the host can know the answer to judge whether a right card was selected and taken by the player. One set of 51 questions and corresponding 51 answers associated with the 51 states, respectively, may be formed to be a question and answer list. A wide variety of sets of questions and answers can be generated by changing the questions, as long as the corresponding answers are associated with the 51 individual states, respectively. Each of the one or more question and answer lists may be formed to be a sheet listing the 51 questions and 51 corresponding answers as in FIG. 2, or a second set of 51 cards reciting the 51 questions and 51 corresponding answers, respectively and separately, which may be provided by the manufacture or distributor of the card game. The host, any of the players or any interested party may choose one of them prior to each time the game is started.

Alternatively, multiple items of state information pertaining to each state may be complied and provided as a database by the manufacture or distributor, and the host or any interested party may randomly choose one item from the multiple items of state information pertaining to each state to generate a set of questions and answers prior to each time the game is started. Here, the sequence of the questions and corresponding answers can be made random as well. Further alternatively, the host or any interested party may randomly choose one item from the multiple items of state information pertaining to each state, which is also chosen randomly, to have a pair of a question and answer prior to posing the question during the game. Such question and answer lists or the database can be updated, changed or expanded as needed by the manufacture or distribution, or a host, a player or any interested party.

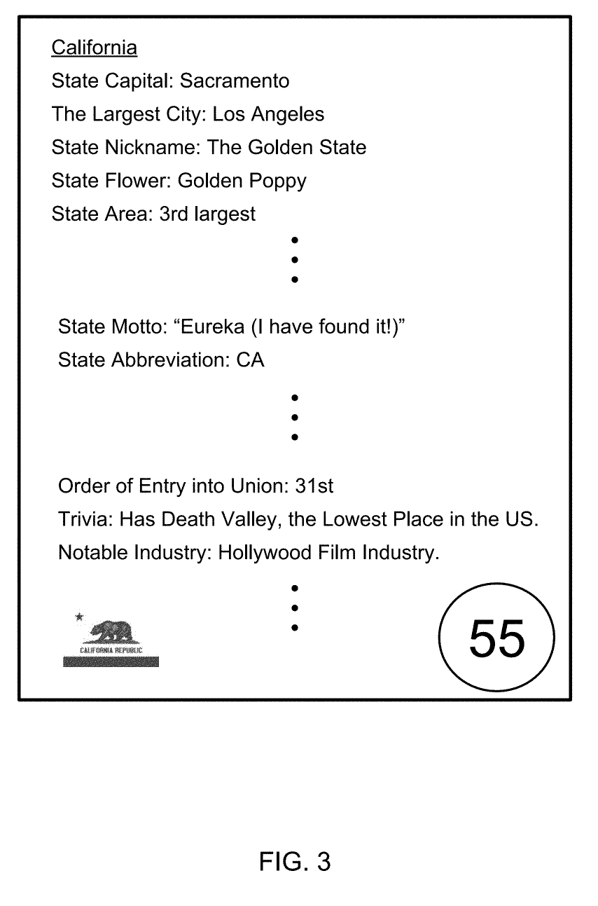

FIG. 3 illustrates an example of a rear view of one of the 51 cards in the set according to an embodiment. This example illustrates what is shown on the back side of the card having the image of the California flag illustrated on the front side. This list includes a wide variety of historical, geographical, political, industrial and other information pertaining to the state of California. Similarly, each of the 50 other cards in the set may be configured to include a list on the back side, the list describing a wide variety of historical, geographical, political, industrial and other state information pertaining to each state. Such a list is termed a state information list hereinafter in this document. There are 51 state information lists corresponding to the 51 states including Washington D.C., respectively, wherein these 51 state information lists may be shown on the back side of the set of cards corresponding to the 51 state flags illustrated on the front side, respectively. The image of the state flag may also be included in the back side, as illustrated in the lower left corner of FIG. 3. A player of the present card game can judge whether or not he/she took a right card, i.e., a correct answer to the question, by looking at the state information list shown on the back side. For example, the question is: Hollywood film industry is a notable industry in what state? The player who selected and took the card with the California state flag can check if he/she took a right card by looking at the back side of the card to find the line: “Notable Industry: Hollywood Film Industry,” as exemplified in FIG. 3. Additionally, whether or not the player took a right card is judged by the host based on the question and answer list. By repeatedly playing the present card game, the players acquire more and more knowledge about the 51 individual states while enjoying the card game. Such knowledge and enjoyment can be further enhanced by using multiple question and answer lists or the database reciting different sets of questions and answers, respectively. Thus, the present card game is designed to be entertaining, enlightening and educational.

The back side of each of the 51 cards may further include the number of electoral votes assigned to the state, reflecting the sum of the representatives and senators it sends to Congress. For example, the number of electoral votes assigned to California is 55, as of the 2012 election, and is shown at the lower right corner of the back side of the card in the example illustrated in FIG. 3. To determine a winner after exhausting the 51 questions, the present card game may include two types of rules. Rule 1 is set in such a way that, after exhausting the 51 questions, the player who picked up the largest number of cards is the winner. This Rule 1 may be termed “Popular.” Rule 2 is set in such a way that, after exhausting the 51 questions, the player who picked up cards aggregating the largest total number of electoral votes is the winner. This Rule 2 may be termed “Electoral.” These rules add a sense of simulating the presidential election to the present card game, thereby making the game a fun tool to educate and enlighten people about the presidential election in the US. The numbers of electoral votes printed on the 51 cards in the set need to be updated each time any of the actual numbers changes.

The number of electoral votes is separated from the items of state information for each state to be used for generating the questions and the corresponding answers. This is because two or more states can have the same number of electoral votes. In this case, the one-to-one relationship between the question and the answer that is one state name cannot be held. For example, Connecticut, Oklahoma and Oregon are assigned with 7 electoral votes as of the 2012 election. As such, there will be three answers to the question: “What state is assigned with 7 electoral votes?” Thus, in the present embodiments, the number of electoral votes for each state is not one of the items to be used for generating the questions and answers.

The number of items in the state information of each state may be any number, i.e., more than, equal to, or less than 51. The number of items of state information pertaining to each state may vary from state to state. In the example of FIG. 3, the back side of each of the 51 cards to be laid/displayed with the front side up shows the name of the state associated with the state flag illustrated on the front side, some items of state information, the number of electoral votes and the small image of the state flag. Alternatively, only the state name and/or only the number of electoral votes may be shown on the back side of each card; or no information or indication about the state may be shown. That is, the back side of each card may be configured to show the name of the state associated with the state flag illustrated on the front side, the number of electoral votes assigned to the state, at least part of the state information pertaining to the state, the image of the state flag or any combination thereof, or none thereof. In any of the above cases, whether or not the player picked up a right card can be judged based on the question and answer list or the database.

In the above examples, the present card game is configured to be physical by using physically fabricated cards such as those made of paper, plastic or other material that provides suitable stiffness and flexibility for handling. In this case, the 51 questions are posed one by one by reading out by the host, based on the question and answer list or the aforementioned database including multiple items of state information pertaining to each state. Alternatively, the present card game can be configured to be electrical by using a computer program, comprising instructions for performing various tasks, with a proper user interface enabling each player to participate in the card game using his/her computer. Here, the computers include but not limited to a desktop computer, a game machine, a smartphone, a laptop computer, and a tablet. Two or more players can be coupled to respective computers. The computer program can be downloaded from a site through the Internet and placed in the computer, distributed directly from the distributer of the card game, or placed externally to the computer, for example, in the cloud environment. A human host is not necessary in the electrical game, since the hosting can be configured by the computer program.

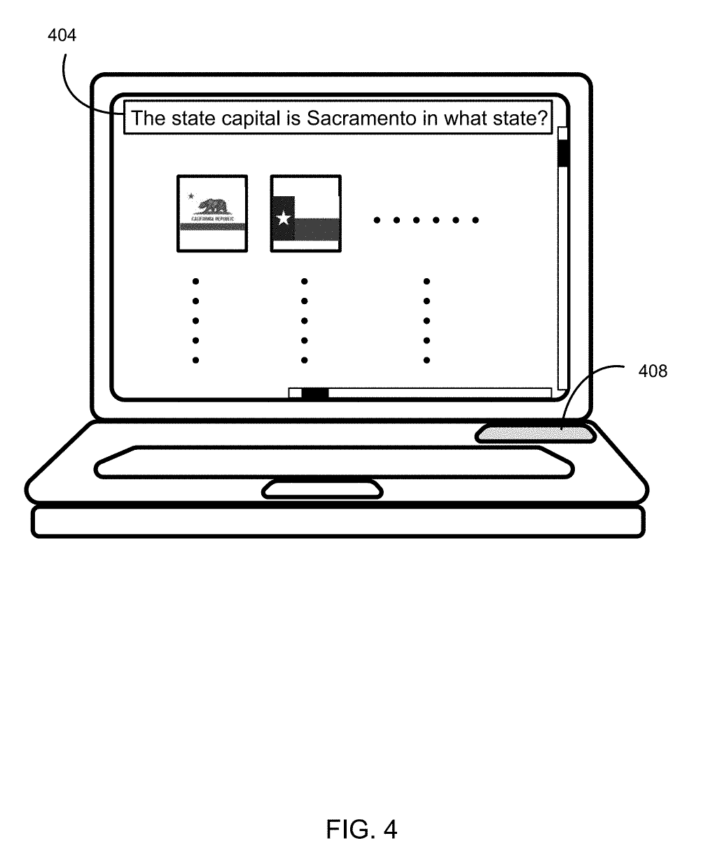

The computer program for carrying out the present card game can be configured to process the graphics, display and other user interface analogously to the physical game. For example, similar to FIG. 1, the cards in the set are displayed substantially in an array on the screen of the computer coupled to each player. Initially, all the cards are displayed showing the front side illustrating the 51 state flags, respectively. In place of physically shuffling the cards prior to starting the game, the computer program can be configured to display the cards in a random arrangement each time the game is started. FIG. 4 illustrates an example of display on the screen of a computer. All 51 cards are displayed substantially in an array, showing the front side illustrating the 51 state flags, respectively. Typically, the entire array cannot be displayed at once on one screen; thus, the player is allowed to use a mouse, a stylus, a finger, or other means coupled with the user interface to scroll and select a card. Such user interfaces can be configured by one with ordinary skill in the art.

As explained earlier, the present card game is configured based on a set of 51 cards having the front side illustrating the 51 state flags, respectively, and 51 questions and corresponding 51 answers associated with the 51 individual states, respectively, including Washington D.C. The computer program can be configured to generate a question and answer list prior to each time the game is started. Instead of using a host as in the physical game, the computer program can be configured to visually pose each question in a section 404 of the screen, an example of which is illustrated in FIG. 4. The section 404 can be located at the top edge portion, left edge portion, right edge portion, bottom edge portion, or any one of the four corner portions of the screen, so as not to interfere with the display of the 51 cards. Alternatively, the computer program can be configured to audibly pose each question by using a speaker 408 of the computer.

Similar to the physical card game, as soon as the questions is posed visually or audibly by the computer, the players compete in speed to pick up a right card that shows a correct answer to the question, wherein the right card has the illustration of the state flag of the state that is the correct answer to the question. In this picking up process, the players are allowed to compete in speed to select a card, for example, by clicking on or touching a card that each player thinks is a right card among the cards displayed on the screen by a mouse, a stylus, a finger, or other means as soon as the question is posed; thereafter, only the player who selects any of the displayed cards first is allowed to take the card. However, the card that the player took may be a wrong card, i.e., a wrong answer to the question. Then, he/she is not allowed to keep the card. Otherwise, he/she is allowed to keep the card. Therefore, to win the game, a player must try to pick up a right card for each question as fast as he/she can. A rule may be set in such a way that he/she must return the wrong card to the display; put the wrong card in a bin; or do some other predetermined action, so as to disallow the player who answered wrong from keeping the card. Optionally, an additional rule may be set so that the player who took a wrong card must be restrained from participation until another player takes a wrong card for one of the subsequent questions. In any case, the wrong card should be placed back in a location where it is available and accessible to all the players as a right card to be selected for another question. A rule may be set in such a way that if the card taken by the first player is wrong, the first player returns the card to the display area, and the player who selected any of the other displayed cards second in speed is allowed to take the card he/she selected or reached; and if the card is right, the second player is allowed to keep the card. An alternative rule may be set in such a way that if the card taken by the first player is wrong, the first player returns the card to the display area, and the game simply proceeds to the next question. Under any rules, only the player who took a right card is allowed to keep the card. Thus, while the game proceeds and the questions are posed one by one, the number of displayed cards to select or reach will decrease as right cards are kept by the players. During any time in the game, for example, while a question is posed, or in between competing in speed, the players may be allowed to rearrange the remaining displayed cards to change the locations of the cards on the display. Alternatively, the computer program may be configured to display the remaining cards in a random arrangement prior to each time a question is posed. Since the location of each card is not fixed in this case, it is difficult for the players to memorize the locations on the display, thereby providing the players with additional enjoyment in dealing with a moving target as in hunting.

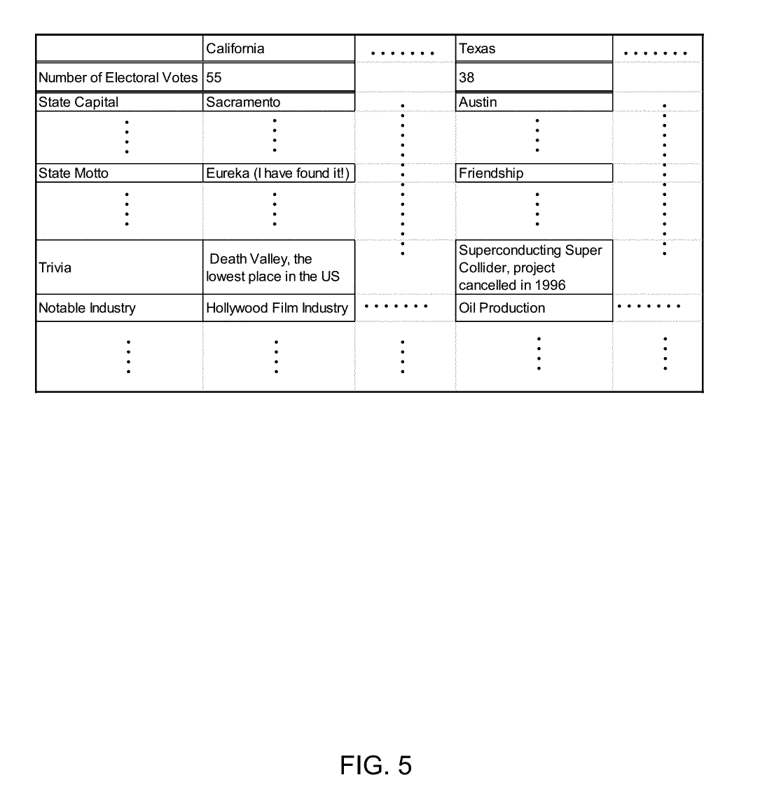

A set of 51 question and 51 corresponding answers may be generated based on state information compiled for each state, which can be stored in a database stored in an electronic storage device that can be coupled to a computer program. The state information may be arranged in a table format. FIG. 5 illustrates an example of a look-up table in which the state information for each state is arranged. Multiple items of the state information pertaining to each state are associated with and related to the state. For example, items such as “the state capital is Austin,” “the state motto is Friendship,” “trivia: Superconducting Super Collider built, but the project cancelled in 1996,” notable industry is oil production,” and other items about history, politics, industry, geography and various topics pertaining to Texas are tabulated under Texas in the table in FIG. 5. Prior to each time the game is started, a question and answer list or a set of 51 questions and 51 corresponding answers can be generated by randomly selecting one item per state, so that 51 questions and 51 corresponding answers, which are the 51 individual state names, respectively, are generated. Supposing there are 10 items of state information associated with each of the 51 states, the number of possible combinations can be 10⁵¹, thereby enabling the generation of a wide variety of 51 questions and 51 corresponding answers, one example of which is illustrated in FIG. 2. The sequence of the 51 questions and 51 corresponding answers in a list or a set can be made random as well. For example, a first state name is selected randomly among the 51 state names to provide a first answer, and one item of the state information associated with the first state name is selected randomly to provide a first question; a second state name is selected randomly among the remaining 50 state names to provide a second answer, and one item of the state information associated with the second state name is selected randomly to provide a second question; and so on. Alternative to generating a set of questions and answers prior to each time the game is started, the computer program can be configured to randomly select one item from the multiple items of state information pertaining to each state, which is also chosen randomly, to have a pair of a question and answer prior to posing the question during the game.

In additions to various items of state information pertaining to each state, which are used for generating one or more sets of the questions and answers, the number of electoral votes assigned to each state can be included, as shown in the first row of the table illustrated in FIG. 5. For example, Texas has 38 electoral votes as of the 2012 election. It is noted here that the number of electoral votes is separated from the items of state information for each state, to be used for generating the one or more sets of questions and answers. This is because two or more states can have the same number of electoral votes. In this case, the one-to-one relationship between the question and answer that is one state name cannot be held. For example, Connecticut, Oklahoma and Oregon are assigned with 7 electoral votes as of the 2012 election. As such, there will be three answers to the question: “What state is assigned with 7 electoral votes?” Thus, the number of electoral votes for each state is separated from the items to be used to generate the one or more sets of questions and answers. The database in the example illustrated in FIG. 5 includes the numbers of electoral votes for the 51 state, respectively. This data may be used for determining the winner based on Rule 2, i.e., “Electoral,” explained earlier, wherein the player who collected cards showing state flags of states aggregating the largest total number of electoral votes is determined to be the winner. The database including the state information for each state and the number of electoral votes for each state can be updated, changed or expanded as needed.

In the table in FIG. 5, the items under the state name in each column represents the items of state information, i.e., the state information list pertaining to the state, used for generating one or more sets of questions and answers. There are 51 state information lists corresponding to the 51 states including Washington D.C., respectively. The number of electoral votes is also tabulated under each state. Analogous to the physical game, the computer program may be configured to display each of these 51 state information lists on the back side of the card illustrating the corresponding state flag on the front side. The information in the database may be retrieved to generate the display of the state information on the back side of each card. The computer program can be configured so that the back side of the card is displayed when a player selects and takes the card after each question is posed in the game, so that the player can judge whether or not he/she took a right card, i.e., a correct answer to the question, by looking at the state information list on the back side. The back side may be shown on the screen by double-clicking the card, for example, or other conventional electrical means. Similar to the physical game, the example in FIG. 3 illustrates what is shown on the back side of the card having the illustration of the California flag on the front side. The state information list includes a wide variety of historical, geographical, political, industrial and other information pertaining to the state of California, corresponding to the state information under California in the database illustrated in FIG. 5.

As in the physical game, the number of items in the state information may be any number, i.e., more than, equal to, or less than 51. The number of items of state information pertaining to each state may vary from state to state. In the example of FIG. 3, the back side of each of the 51 cards to be laid/displayed with the front side up shows the name of the state associated with the state flag illustrated on the front side, some items of state information, the number of electoral votes and the small image of the state flag. Alternatively, only the state name and/or only the number of electoral votes may be shown on the back side of each card; or no information or indication about the state may be shown. That is, the back side of each card may be configured to show the name of the state associated with the state flag illustrated on the front side, the number of electoral votes assigned to the state, at least part of the state information pertaining to the state, the image of the state flag or any combination thereof, or none thereof. In any of the above cases, whether or not the player took a right card can be judged by the computer program based on the question and answer list of the database.

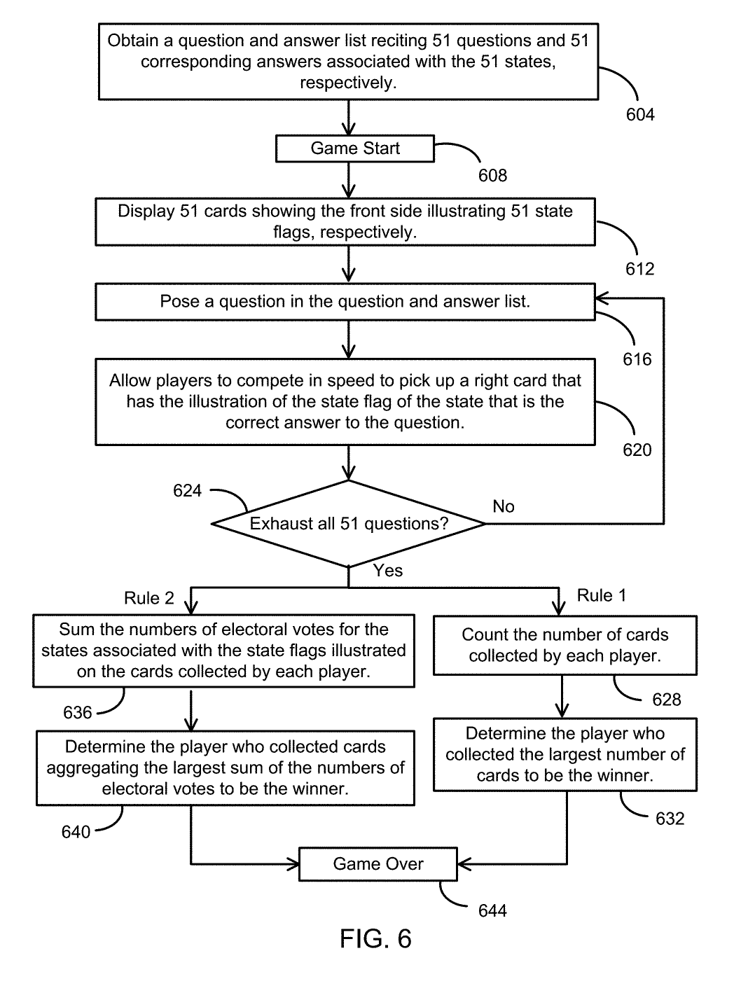

FIG. 6 is a flowchart illustrating an example of the process of carrying out the present card game. The card game can be configured to be physical by using physically fabricated cards such as those made of paper, plastic or other material, or electrical by using a computer program. In step 604, a question and answer list reciting 51 questions and 51 corresponding answers associated with the 51 states, respectively, is obtained. The question and answer list can be generated based on information such as history, politics, industry, geography and other topics pertaining to the individual states. It is possible to generate a wide variety of questions and answers. One or more question and answer lists may be provided on separate sheets, for example, by the manufacturer or distributer of the card game. Thus, the obtaining in step 604 may include selecting one question and answer list from the two or more lists provided prior to starting the game. Alternatively, the host may prepare a list based on the data compiling state information for each state provided by the manufacturer or distributer of the card game. For the case of the electrical game, a computer program coupled with a database can be configured to generate a question and answer list prior to each time the game is started by randomly selecting one item from multiple items of state information pertaining to each state by looking up the database storing the state information for each state. An example of such a database is explained earlier with reference to FIG. 5. Supposing there are 10 items of state information associated with each of the 51 states in the database, the number of possible combinations can be 10⁵¹, thereby enabling the generation of a wide variety of question and answer lists, one example of which is illustrated in FIG. 2. The sequence of the 51 questions and 51 corresponding answers in a list can be made in a random order as well.

As soon as the game is started in step 608, 51 cards showing the front side illustrating 51 state flags, respectively, are displayed substantially in an array in step 612. In the physical game, these 51 cards can be laid on a table, a floor or other surface, as illustrated in FIG. 1. In the electrical game, the compute program can be configured to display the images of the 51 cards showing the 51 state flags on a screen of the computer with which each player is coupled, as illustrated in FIG. 4.

In step 616, a question in the question and answer list is posed. In the physical game, the question may be read out by the host. In the electrical game, the computer program can be configured to visually pose the question in a section of the screen, or audibly pose each question by using a speaker of the computer, as illustrated in FIG. 4.

As soon as the question is posed in step 616, in step 620 the players are allowed to compete in speed to pick up a right card that has the illustration of the state flag of the state that is the correct answer to the question. The picking up a right card may include three steps: first, the players are allowed to compete in speed to select a card as soon as the question is posed; second, only the player who selected any of the displayed cards first is allowed to take the card; third, the player is allowed to keep the card if the card that he/she took is a right card, i.e., a right answer to the question, otherwise, he/she is not allowed to keep the card that he/she took. The selecting a card may include physically reaching a card that each player thinks is a right card among the cards laid on a table, a floor, or other surface in the physical game; or clicking on or touching a card that each player thinks is a right card among the cards displayed on the screen by a mouse, a stylus, a finger, or other means in the electrical game. During any time in the game, for example, while a question is posed, or in between competing in speed, the players may be allowed to rearrange the remaining displayed cards to change the locations of the cards on the display. Alternatively, the computer program may be configured to display the remaining displayed cards in a random arrangement prior to each time a question is posed. Since the location of each card is not fixed in this case, it is difficult for the players to memorize the locations, thereby providing the players with additional enjoyment in dealing with a moving target as in hunting.

The steps 616 and 620 are repeated until it is judged in 624 that all the 51 questions are exhausted. To determine the winner, the present card game may use Rule 1 or Rule 2. When Rule 1 is applied, the process proceeds to steps 628 and 632. In step 628, the number of cards collected by each player is counted. In step 632, the player who collected the largest number of cards is determined to be the winner. When Rule 2 is applied, the process proceeds to steps 636 and 640. In step 636, the numbers of electoral votes are summed for the states associated with the state flags illustrated on the cards collected by each player. In step 640, the player who collected cards aggregating the largest sum of the numbers of electoral votes is determined to be the winner. When the winner is determined, the game is over in step 644.

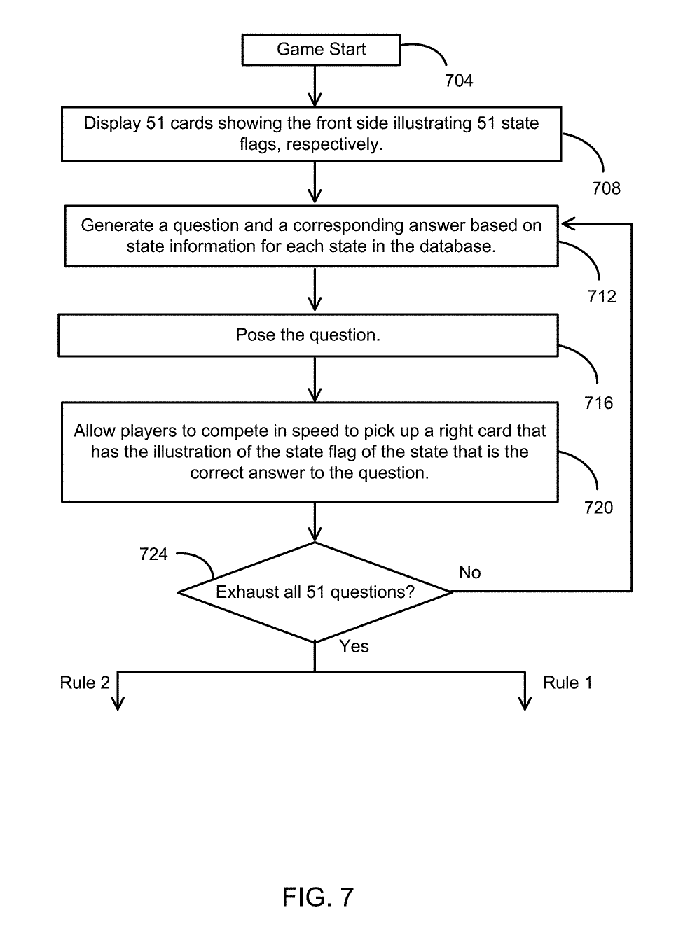

FIG. 7 is a flowchart illustrating another example of the process of carrying out the present card game. In this example for the case of the electrical game, the computer program can be configured to generate a question and a corresponding answer prior to each time the question is posed during the game, instead of generating a question and answer list prior to each time the game is started as in the process illustrated in FIG. 6. The game is started in step 704, and 51 cards showing the front side illustrating 51 state flags, respectively, are displayed in a random arrangement on the screen substantially in an array in step 708, as illustrated in FIG. 4. In step 712, a pair of a question and a corresponding answer is generated based on state information for each state stored in a database, an example of which is illustrated in FIG. 5. Specifically, a first state name is selected randomly among the 51 state names to provide a first answer, and one item of the state information associated with the first state name is selected randomly to provide a first question, prior to posing the first question; a second state name is selected randomly among the remaining 50 state names to provide a second answer, and one item of the state information associated with the second state name is selected randomly to provide a second question, prior to posing the second question; and so on. In step 716, the question is posed visually or audibly, as illustrated in FIG. 4. In step 720, the players are allowed to compete in speed to pick up a right card that has the illustration of the state flag of the state that is the correct answer to the question. The steps 712-720 are repeated until it is judged in 724 that all the 51 questions pertaining to 51 states, respectively, are exhausted. To determine the winner, the present card game may use Rule 1 or Rule 2, and the process proceeds to step 628 or step 636, as illustrated in FIG. 6.

The electrically configured card game described herein can be implemented in digital electronic circuitry, or in computer hardware, firmware, software, or in a combination thereof. The implementation can be made using a computer program product for execution by, or to control the operation of data processing apparatus, e.g., a programmable processor, coupled with a computer. Here, the computers include but not limited to a desktop computer, a game machine, a smartphone, a laptop computer, and a tablet. Two or more players can be coupled to respective computers. The computer program product can be downloaded from a site through the Internet and placed in the computer, distributed directly from the distributer of the card game, or placed externally to the computer, for example, in the cloud environment. The computer program product can include a database storing state information pertaining to each state and the number of electoral votes assigned to each state to be used for executing the computer program by a processor, wherein the database can be updated, changed and expanded as needed.

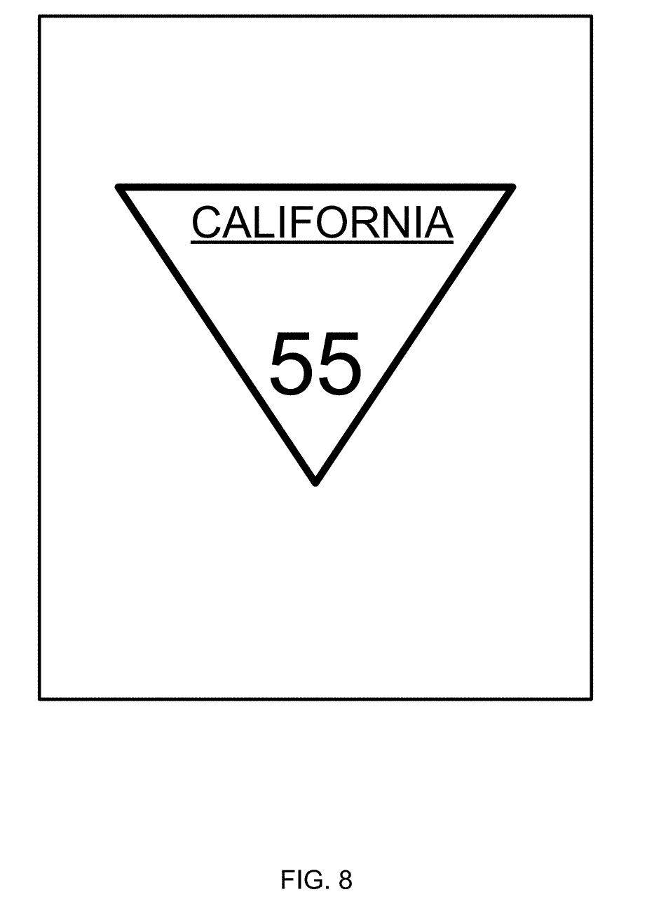

Referring back to FIG. 3 illustrating the back side of the card having the image of the California flag on the front side, it was mentioned earlier that the back side of each card may be configured to show the name of the state associated with the state flag illustrated on the front side, the number of electoral votes assigned to the state, at least part of the state information pertaining to the state, the image of the state flag or any combination thereof, or none thereof. However, in order for the card game to be interesting and challenging, the rule 2 incorporating the numbers of electoral votes, as illustrated in FIG. 6, will be likely preferred by general players. Therefore, the back side of each card should have at least the name of the state associated with the state flag illustrated on the front side and the number of electoral votes assigned to the state. Furthermore, having less letters or words makes it easy for players to learn the information during the game. FIG. 8 illustrates another example illustrating the back side of the card having the image of the California state flag on the front side. The name of the state, California, and the number of assigned electoral votes, 55, are shown on the back side with an inverse triangle enclosing the two pieces of information in this example. The design can be configured with any shape and/or any color; for example, the enclosure may be shaped similar to a geographical outline of California, an outline of a surfer and a surfboard, an illustration of sunshine, etc. Similarly, the back side of the other 50 cards corresponding to the other 50 states can be designed to show at least the names of the states and the numbers of electoral votes, respectively.

Again, referring back to FIG. 3, it was explained earlier that this figure illustrates the back side of the card having the image of the California flag on the front side, which is one of the first set of the 51 cards to be laid with the front side up in front of the players. Another set of cards with the similar design may be used for the host of the game to pose questions. Namely, a second set of 51 cards can be made for use for posing questions, wherein each card shows the name of one of the 51 states, the number of electoral votes assigned to the state, at least part of the state information pertaining to the state, and the image of the state flag, as illustrated in the example of FIG. 3, so that the host of the game can hold the second set of the 51 cards to read out 51 questions pertaining to 51 states, respectively, one by one. The host can select one of the items of the state information written of the card to pose a question pertaining to the state. The selection can be random or depend on how the host judges the knowledge level of the players. Therefore, each of the second set of 51 cards for use for questioning should show at least the name of one of the 51 states and multiple items of state information pertaining to the state.

Alternative to the second set of 51 cards designed as above for use for questioning, all the information on the second set of the 51 cards can be combined as a database and/or written in a format, such as a table, for viewing, enabling the host to select and read out the questions. Thus, the present second set of the cards or the table combining all the information provides one or more different sets of questions and answers, allowing the players to enjoy variations in the game.

According to the embodiments explained above with reference to FIGS. 1-8, a game product comprising a game system may be provided for playing games based on information pertaining to 51 individual states in the USA including Washington D.C. The information includes a wide variety of historical, geographical, political, industrial and other state information pertaining to each state. An example of such a game system includes: a set of 51 cards having a front side illustrating 51 state flags, respectively, wherein a back side of each of the 51 cards is configured to show at least the name of the state associated with the state flag illustrated on the front side and the number of electoral votes assigned to the state; and a question and answer unit configured to provide one or more sets of questions and answers, each set providing 51 questions and 51 corresponding answers related to state information pertaining to the 51 states, respectively. Each question requires a plurality of players to compete in speed to pick up a right card among the cards with the front side up laid in a random arrangement. Here, a right card is defined to be the card illustrating the state flag of the state that is a correct answer to the question. The 51 questions are posed one by one. A winner of a game is determined based on determining the player who collected the largest number of cards (popular) or determining the player who collected cards aggregating the largest sum of electoral votes assigned to the states associated with the state flags illustrated on the collected cards, respectively (electoral).

Thus, the set of 51 cards in the present game system are configured to have the front side illustrating 51 state flags, respectively, as illustrated in FIG. 1, and the back side of each of the 51 cards is configured to show at least the name of the state associated with the state flag illustrated on the front side and the number of electoral votes assigned to the state, as illustrated in FIG. 8. These 51 cards are initially laid in a random arrangement with the front side up for the players to pick up a right card among them. The back side of each of the 51 cards may be configured to further show at least part of the state information pertaining to the state associated with the state flag illustrated on the front side, as illustrated in FIG. 3. The back side of each of the 51 cards may be configured to further show additional images or words representing the state such as a small image of the state flag, a geometrical shape of the state, etc., and/or any abstract shape in any colors.

The question and answer unit in the present game system provides the one or more sets of questions and answers, which may be configured to form one or more different lists, respectively, of 51 questions and 51 corresponding answers. Each list may include the 51 questions and 51 corresponding answers with a one-to-one relationship, as illustrated in FIG. 2. Thus, each list may be formed to be a second set of 51 cards showing the 51 questions and the 51 corresponding answers, respectively and separately; or a sheet showing the 51 questions and the 51 corresponding answers with the one-to-one relationship, as exemplified in FIG. 2. The cards or the sheets may be physically fabricated based on paper, plastic, or other material that provides suitable stiffness and flexibility for handling. Alternatively, the cards or the sheets may be electrically formatted to be stored in an electronic storage device, such as a compact disc (CD), flash memory, USB flash drive, or any other computer-readable storage media. The one or more lists in the question and answer unit may be provided by the manufacture or distributor of the card game; and the host, any of the players or any interested party such as teachers or parents may choose one of them prior to each time the game is started.

As explained with reference to FIG. 5, there are a wide variety of 51 questions and 51 corresponding answers. Supposing there are 10 items of state information associated with each of the 51 states, the number of possible combinations can be 10⁵¹, corresponding to 10⁵¹ different sets of questions and corresponding answers, one example of which is illustrated in FIG. 2. For this reason, the question and answer unit of the present game system may be configured to include a database stored in an electronic storage device or written in a format for viewing, the database including a plurality of items of state information pertaining to each state. The database may be formatted to include a look-up table having the plurality of items of state information pertaining to each state, an example of which is illustrated in FIG. 5. Another example, explained earlier with reference to FIG. 3 is to have the second set of 51 cards designed as in FIG. 3 for use for posing questions as part of the question and answer unit, or to combine all the information on the second set of the 51 cards and write in a format such as a table on one or more sheets of paper or plastic, for viewing. The electronic storage device may be a compact disc (CD), flash memory, USB flash drive, or any other computer-readable storage media. That is, the database can be configured to be electrical or physical. Examples of the database that are physically made and written in a format for viewing may include a look-up table written on one or more sheets of paper or plastic. Example of the database that are electrically formatted may include a look-up table in a spreadsheet data format to be viewed on a computer screen or a smartphone screen when opened using an appropriate program or application.

The database may be included in the question and answer unit, alternatively or additionally to the one or more lists of questions and answers pre-fabricated as illustrated in FIG. 2. The 51 questions and the 51 corresponding answers for each game may be generated by randomly selecting one item from the plurality of items of state information pertaining to each state by using the database. The selection can be made by the host randomly or depending on how the host judges the knowledge level of the players. The selection can be made prior to the start of a game to form a list of the 51 selected questions and the 51 corresponding answers. Alternatively, the selection can be made one by one prior to the posing of each question to form a pair of the selected question and the corresponding answer. The database may further include the number of electoral votes assigned to each state. The database may be configured to be updated, changed and expanded as needed by the manufacturer or distributer of the game system, any game players or hosts, or any interested party such as parents or teachers. The sequence of the 51 questions and 51 corresponding answers for each game can be made random as well. For example, a first state name is selected randomly among the 51 state names to provide a first answer, and one item of the state information associated with the first state name is selected randomly to provide a first question; a second state name is selected randomly among the remaining 50 state names to provide a second answer, and one item of the state information associated with the second state name is selected randomly to provide a second question; and so on.

During the game, the 51 questions may be audibly read out randomly or sequentially by a host. Alternatively, the 51 questions may be configured to be audibly read out randomly or sequentially by using a speaker coupled to a computer, by using technologies known to those skilled in the art. For example, a program or an application can be used to convert the information in the look-up table to voice signals to be emitted from the speaker coupled to the computer.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A game system for playing games based on information pertaining to 51 individual states in the USA including Washington D.C., the game system comprising:
a set of 51 cards having a front side illustrating 51 state flags, respectively, wherein a back side of each of the 51 cards is configured to show at least the name of the state associated with the state flag illustrated on the front side and the number of electoral votes assigned to the state; and
a question and answer unit configured to provide one or more sets of questions and answers, each set including 51 questions and 51 corresponding answers related to state information pertaining to the 51 states, respectively, each question requiring a plurality of players to compete in speed to pick up a right card among the cards with the front side up laid in a random arrangement, the right card illustrating the state flag of the state that is a correct answer to the question;
wherein a winner of a game is determined based on determining the player who collected the largest number of cards or determining the player who collected cards aggregating the largest sum of electoral votes assigned to the states associated with the state flags illustrated on the collected cards, respectively.

2. The game system of claim 1, wherein
the one or more sets of questions and answers are configured to form one or more different lists, respectively, of 51 questions and 51 corresponding answers.

3. The game system of claim 2, wherein
each of the one or more lists is formed to be a second set of 51 cards showing the 51 questions and the 51 corresponding answers, respectively and separately, or a sheet showing the 51 questions and the 51 corresponding answers.

4. The game system of claim 1, wherein
the question and answer unit includes a database stored in an electronic storage device or written in a format for viewing, the database including a plurality of items of state information pertaining to each state.

5. The game system of claim 4, wherein
the database is formed to have a look-up table having the plurality of items of state information pertaining to each state.

6. The game system of claim 4, wherein
the database is configured to be electrical or physical.

7. The game system of claim 4, wherein
the database is formed to have a second set of 51 cards showing at least the names of and the plurality of items of state information pertaining to the 51 states, respectively and separately.

8. The game system of claim 4, wherein
the 51 questions and the 51 corresponding answers for each game are generated by randomly selecting one item from the plurality of items of state information pertaining to each state by using the database.

9. The game system of claim 4, wherein
the database further includes the number of electoral votes assigned to each state.

10. The game system of claim 4, wherein
the database is configured to be updated, changed and expanded as needed.

11. The game system of claim 1, wherein
the 51 questions are configured to be audibly read out randomly or sequentially by a host.

12. The game system of claim 1, wherein
the 51 questions are configured to be audibly read out randomly or sequentially by using a speaker coupled to a computer.

13. The game system of claim 1, wherein
the back side of each of the 51 cards is configured to further show at least part of the state information pertaining to the state associated with the state flag illustrated on the front side, wherein the set of the 51 cards are initially laid in a random arrangement with the front side up for the plurality of players to pick up a right card among them.
